(19) United States
(12) Patent Application Publication
(10) Pub. No.: US 2002/0174173 A1
(43) Pub. Date: Nov. 21, 2002

(54) Self-downloading network client

(76) Inventor: Ravindranath Gunturu, Dublin, CA (US)

Correspondence Address: JAMES TROSINO, ONE SANSOME STREET, SUITE 2000, #20003, SAN FRANCISCO, CA, 94104, US

(21) Appl. No.: 09/823,035

(22) Filed: Mar. 30, 2001

(51) Int. Cl. G06F 3/00; B41J 1/00; B41B 1/00; G06K 1/00; B41F 1/00; G06F 15/00; G06F 9/445; G06F 15/16

(52) U.S. Cl. 709/203; 710/1; 358/1.15; 717/178

(57) ABSTRACT

A computer server-client network initially places all client software on the servers except for a client-downloader utility that polls the network from otherwise empty and unititialized client hardware. When a broadcast from the client-downloader utility is responded to by an appropriate server, the client software is downloaded to the client site. The client agent is initialized and normal server-client operations over the network commence. In alternative embodiments, the client-downloader utility continues to identify itself on the network and solicits automatic downloads of updated or upgraded client software from the server.

### BACKGROUND OF THE INVENTION

1. Technical Field

The invention relates to computer networking systems. More particularly, the invention relates to systems that initially place all client software on the servers except for a client-downloader utility that polls the network from otherwise empty and unititialized client hardware.

2. Description of the Prior Art

Large networks and large production runs of server-client pairs can require many instances of network clients. Such clients are typically implemented with very specialized agent programs that run on generalized client hardware platforms. The synchronizing of servers and clients with the latest program revisions and with the correct agents for the jobs being deployed can require an extraordinary amount of effort by skilled technicians, and still mistakes can be made.

### SUMMARY OF THE INVENTION

A computer server-client network embodiment of the invention initially places all client software on the servers except for a client-downloader utility that polls the network from otherwise empty and unititialized client hardware. When a broadcast from the client-downloader utility is responded to by an appropriate server, the client software is downloaded to the client site. The client agent is initialized and normal server-client operations over the network commence. In alternative embodiments, the client-downloader utility continues to identify itself on the network and solicits automatic downloads of updated or upgraded client software from the server.

### BRIEF DESCRIPTION OF THE DRAWINGS

FIG. 1 is a functional block diagram of a printing system embodiment of the invention; and

FIG. 2 is a flowchart of a method embodiment of the invention that initially places all client software on the servers except for a client-downloader utility that polls the network from otherwise empty and unititialized client hardware.

### DETAILED DESCRIPTION OF THE INVENTION

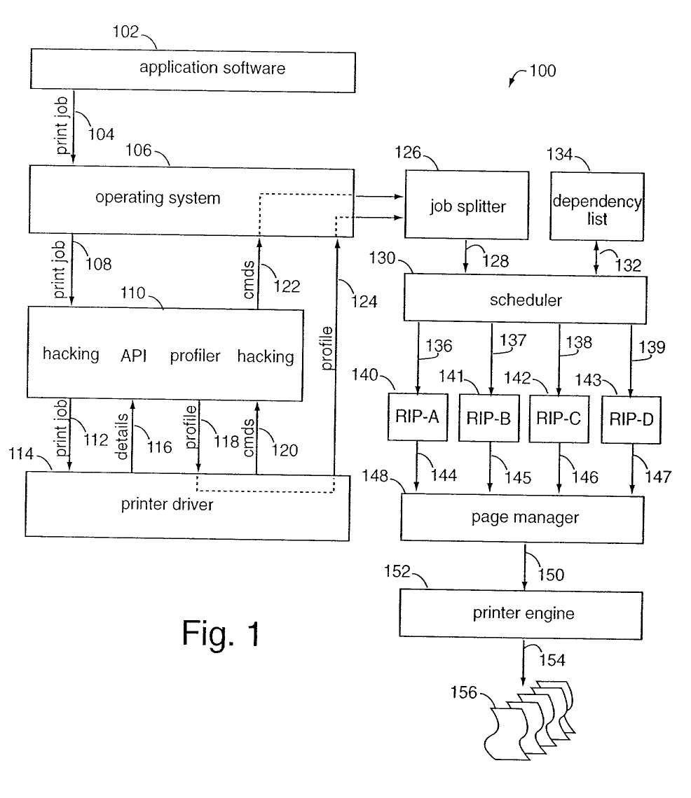

FIG. 1 represents a printing system embodiment of the invention, referred to herein by the general reference numeral 100. The printing system 100 is used with an application software program 102 that can periodically issue multi-page print job requests 104 to an operating system 106. For example, the application software program 102 can be similar to Microsoft WORD, Adobe ILLUSTRATOR, Aldus PAGEMAKER, etc. The operating system 106 can be similar to Microsoft WINDOWS, Apple Computer MAC/OS, UNIX, etc.

The operating system 106 forwards all the information to print all the pages of a print job 108. This information is intercepted by a profiler 110 which includes an incoming hacking function and an outgoing hacking function. The print job can include a request to draw graphics to a printer and is passed on as a print job 112 to a printer driver 114. If the printer driver supports a profiler application program interface (API), very accurate and detailed profile information 116 is provided back to the profiler 110. A page profile 118 summarizes the resources needed by particular pages and is appended at the page end. A command stream 120 for drawing the text and graphics objects on the pages is generated by the printer driver 114. The implementation of the profiler 110 can be assisted by referring to the description for a system for estimating raster-image processing times in U.S. Pat. No. 5,473,741, issued Dec. 5, 1995, to Thomas Neufelder. Such patent is incorporated herein by reference.

An application program interface (API) is a set of tools that allows programmers to write applications that let one computer operating system or program make requests of another, different operating system or program. Such bridge between operating systems or programs can integrate otherwise incompatible systems. A wide range of services may be required of an API to support applications. These services include procedures, operations, shared data objects, and resolution of identifiers. An API can be contrasted with a graphical user interface (GUI) or a command interface, both of which are direct user interfaces. Information flows across an API boundary in a format defined by the particular programming language, and lets users access the services provided by the application on the other side of the boundary. Such requires mapping the specification of the functions available at the application platform into the syntax of the programming language.

A command stream 122 and a corresponding profile 124 are sent page-by-page through the operating system 106 to a job splitter 126. These are combined into a composite stream 128 for a page job-scheduler 130. Any page dependencies 132 are stored in a list 134, e.g., a third page depends on resources in the second page. The scheduler 130 determines which of several raster-image processors should receive the job of processing particular pages, given the page dependencies held in the dependency list 134. The objective of the scheduling is to have the fastest throughput of the printed pages that is possible.

The scheduler 130 parses the print job into four streams 136-139, one for each of a raster-image processor 140-143. Individual bitmap streams 144-147 are then combined into proper page order by a page manager 148. A rendered page stream 150 is then sent to a printer engine 152. An output 154 will then produce the requested printed pages 156.

The profiler 110 inserts a profile for each page at the end of the command stream for the page. Each profile includes a description of the command stream complexity, and a list of any resource dependencies. A complex command stream can slow down the raster-image processing by loading down the central processing unit (CPU) with compute-intensive tasks. Resource dependencies can slow down and even halt the raster-image processing by making it execute null instructions in a wait loop. The profiler estimates the raster-image processing time for the command streams, and lists the resource dependencies. The scheduler then uses the profiler data to dispatch the pages to be raster-image processed.

One policy the scheduler 130 may follow when the dependencies list 134 says one page depends on another, is not to sequentially dispatch the raster-image processing in parallel to two different RIP's 140-143. An example is represented in Table I where there are only two RIP's. If page-2 depends on resources from page-1, and page-3 and page-4 are independent, then the scheduler should send page-1 to the first RIP, and page-3 to the second RIP. Once these are finished, page-2 can be sent to the first RIP and page-4 to the second RIP. Page-1 can print in time slot 3, but page-2 must finish in RIP-1 and then print in time-slot 3 before page-3 can print in time slot 4. Such recombining and ordering is done b y the page manager 148. The ordering in Table I minimizes the idle times that is experienced by the RIP's.

TABLE I

| | time slot 1 | time slot 2 | time slot 3 | time slot 4 | time slot 5 |
|---|---|---|---|---|---|
| RIP-1 | page-1 | page-2* | | | |
| RIP-2 | page-3 | page-4 | | | |
| print engine | | page-1 | page-2 | page-3 | page-4 |

*depends on page-1

Table II represents an instance where page-3 is relatively complex, and all of the pages are independent. The processing of page-3 can preferably be begun immediately because it takes as much time for RIP-2 to process it than RIP-1 takes to process all the other pages one after the other. Such policy minimizes the idle times that are experienced by all the RIP's.

TABLE II

| | time slot 1 | time slot 2 | time slot 3 | time slot 4 | time slot 5 |
|---|---|---|---|---|---|
| RIP-1 | page-1 | page-2 | page-4 | | |
| RIP-2 | page-3 | | | | |
| print engine | | page-1 | page-2 | page-3 | page-4 |

In some embodiments of the present invention, one of the RIP's 140-143 could be implemented to be more capable and faster executing than the others, e.g., to save on manufacturing costs. The complexity estimates could then be used to send the complex processing jobs to this more capable RIP.

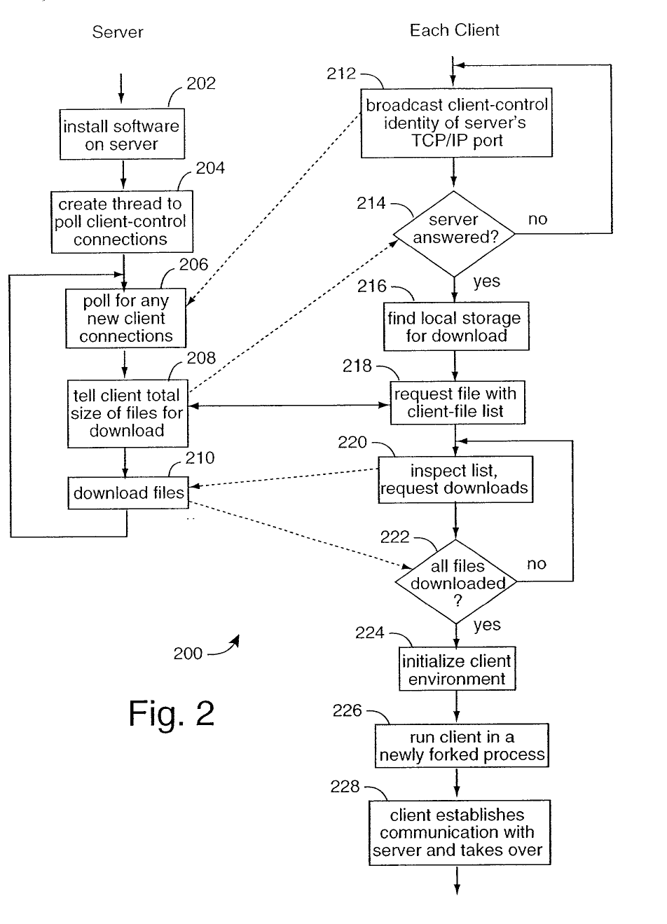

FIG. 2 is a flowchart of a method embodiment of the invention, and is referred to herein by the general reference numeral 200. Such method embodiments initially place all client software on the servers except for a client-downloader utility that polls the network from otherwise empty and unititialized client hardware. Method 200 is very useful in combination with the printing system described herein in connection with FIG. 1. In such case, the printer becomes the network agent and the application program and printer drives become the server.

Method 200 relates to a server and a client that are able to communicate over a network connection. There can be many servers and clients, or just one pair of them. In practical implementations of method 200, a simple client-control computer program is pre-installed on client hardware. All the operational client software, e.g. a client agent, is loaded on its server. At this point, the client is only capable of asking a server to respond on the network for a download. If the client gets an answer, and a download is completed, then the client is actually able to function as a regular client in the network. But until then, no agent exists in the client to respond to the regular work of the server.

A program that executes on each server begins with a step 202 in which all the client software is loaded on the server and not the client. Albeit, the client gets a small client-download utility that can later download these client files from the server to the client. A step 204 creates a program thread to look for any such small client-download utilities that are connected to the server and soliciting such a download.

A step 206 polls for new client connections over operational time. When a request for download is identified, a step 208 warns the client site how big the downloads are. The client then has to find a place to put them. A step 210 waits for the request to start downloading files, and then downloads them all. Program control then loops to look for other clients in the network that need to download their initial configurations too.

A client-control utility program is the only client-application program initially installed at a client site. There well may be other unrelated applications and supporting operating systems already installed. The client-control utility program is a seed that germinates downloads from the server, e.g. if any are connected and can satisfy the request. A step 212 broadcasts the client-control program identity and IP-address on a common port expected to be used by the server. A step 214 looks to see if any servers have answered. If answered, the response tells the client-control utility the size of the impending download. In a step 216, room in local storage must be found. In a step 218, a list of files to download is requested. A step 220 requests specific files for downloads, and a step 222 checks to see if all have been downloaded. A step 224 is then able to initialize the target client environment by executing the client files downloaded by the server. If the client program crashed at this point, the client-control utility could resume control and try a new download. A step 226 forks a new process and runs it. Normal server-client operation begin in a step 228.

In alternative embodiments of the present invention, it will be preferable for the client-control utility to check and see if the server has any newer, updated files. If so, such files would be automatically downloaded and used.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A server-client network environment, comprising:
a not-as-yet operational client site comprising a client-hardware platform not loaded with any client-software application program;
a fully operational server site comprising a server-hardware platform, a server-software application program, and a client-software application program; and
a client-control utility program installed on the not-as-yet operational client site and providing for an automated download of said client-software application program from the server site.

2. The server-client network environment of claim 1, wherein:
the client-control utility program provides for broadcasts of its identity on a computer network that interconnects the client site and the server site.

3. The server-client network environment of claim 1, wherein:
the server is responsive to broadcasts from the client-control utility program over a computer network that interconnects the client site and the server site.

4. The server-client network environment of claim 1, wherein:
the client-control utility program provides for client initialization after downloading said client-software application program.

5. The server-client network environment of claim 1, further comprising a printing system including:
a plurality of raster-image processors (RIP's) for converting page description language commands into a bitmap for a printer engine;
a profiler for receiving multiple-page print requests from a computer application program and operating system, and providing a complexity estimate of the command language stream for each print-page and a dependency list of any inter-print-page resources; and
a scheduler connected to receive said complexity estimates and said dependency list, and able to dispatch individual print-page raster-image processor jobs to particular RIP's depending on said complexity estimates and said dependency list.

6. The server-client network environment and printing system of claim 5, further comprising:
a page manager connected to receive finished raster-image processing jobs from each of the RIP's in whatever order they are completed, and then able to output such in an original page order.

7. The server-client network environment and printing system of claim 5, wherein:
the scheduler is such that said complexity estimates and said dependency list are used to minimize idle times for the RIP's.

8. The server-client network environment and printing system of claim 5, wherein:
the profiler is such that it includes an application program interface (API) that is used to provide detailed profile information to the scheduler in a print command stream.

9. The server-client network environment and printing system of claim 5, wherein:
the profiler is connected to a printer driver through an application program interface (API), and thereby provides a profile information to the scheduler in a print command stream.

10. A method of printing multi-page documents with multiple raster-image processors (RIP's), the method comprising:
deploying a not-as-yet operational client site comprising a client-hardware platform not loaded with any client-software application program;
placing on-line a fully operational server site comprising a server-hardware platform, a server-software application program, and a client-software application program;
installing a client-control utility program on the not-as-yet operational client site and providing for an automated download of said client-software application program from the server site;
profiling the command stream complexities and resource dependencies of a series of pages to be printed;
associating a profile of the command stream complexities and resource dependencies of a series of pages to be printed with a printing command stream; and
dispatching individual raster-image processor jobs for each of said pages to be printed to particular RIP's according to said profile.

11. The method of claim 10, wherein:
the step of dispatching is such that said complexity estimates and said dependency list are used to minimize idle times for the RIP's.

12. The method of claim 10, further comprising:
collecting the individual outputs of each raster-image processor and recombining them back into a page-ordered sequence for a print engine.
